(19) United States
(12) Patent Application Publication
(10) Pub. No.: US 2005/0088572 A1
(43) Pub. Date: Apr. 28, 2005

(54) System and method for a camera docking station

(76) Inventors: Amol S. Pandit, Greeley, CO (US); Wan Kum Wai, Singapore (SG); Daniel J. Byme, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/695,571

(22) Filed: Oct. 28, 2003

(51) Int. Cl. H04N 5/225

(52) U.S. Cl. 348/375

(57) ABSTRACT

The present invention provides a system and method for docking a camera. Briefly described, one embodiment is a method comprising coupling a camera to a docking station platform and rotating the camera about an axis of rotation, the rotation permitted by the docking station platform configured to couple to a docking station base such that the docking station platform may be rotated about the axis of rotation.

### TECHNICAL FIELD

The present invention is generally related to image capture devices and, more particularly, is related to a system and method for a camera docking station.

### BACKGROUND

Camera docking stations provide a convenient system for communicatively coupling a camera to a processing system when the camera is physically coupled to the docking station. Since the docking station is communicatively coupled with a processing system, captured image data and/or related data may be communicated from the camera to the processing system via the docking station. Because docking stations require the camera to be physically coupled to the docking station so that the electrical connectors of the camera and the docking station are in contact with each other, the position of the camera is fixed upon docking.

With some embodiments, the camera is coupled to the docking station such that the back of the camera faces the front of the docking station. Accordingly, a user has convenient access to camera controls located at the back, top and/or sides when the camera is coupled to the docking station. However, with such a camera docking station system, the camera cannot be conveniently used to capture images when docked since the camera position is fixed, and since the camera lens is generally facing away from the user.

### SUMMARY

The user assistance system provides a system and method for assisting a user in operation of an image capture device. Briefly described, one embodiment is a method comprising coupling a camera to a docking station platform and rotating the camera about an axis of rotation, the rotation permitted by the docking station platform configured to couple to a docking station base such that the docking station platform may be rotated about the axis of rotation.

Another embodiment comprises a base and a platform configured to dock with the camera and configured to couple to the base such that the platform may be rotated about an axis of rotation.

### BRIEF DESCRIPTION OF THE DRAWINGS

The components in the drawings are not necessarily to scale relative to each other. Like reference numerals designate corresponding parts throughout the several views.

FIG. 1 is a perspective view of a camera coupled to an embodiment of a camera docking station.

FIG. 2 is a perspective view of the back side of the camera coupled to an embodiment of the camera docking station.

FIG. 3 is an exploded view of the docking station platform separated from an embodiment of the docking station base.

FIG. 4 is an exploded view of an embodiment of docking station platform separated from the docking station base.

FIG. 5 is an exploded view of another embodiment of docking station platform separated from the docking station base.

FIG. 6 is a perspective view of an embodiment of a platform with a platform cavity corresponding to the base of camera.

FIG. 7 is a perspective view of an embodiment of a camera docking station comprising a tripod.

FIG. 8 is a perspective view of an embodiment of a camera docking station comprising a pedestal.

FIG. 9 is a block diagram of a communication device in communication with camera and a processing system.

FIG. 10 is a flowchart illustrating a process of using an embodiment of the camera docking station.

### DETAILED DESCRIPTION

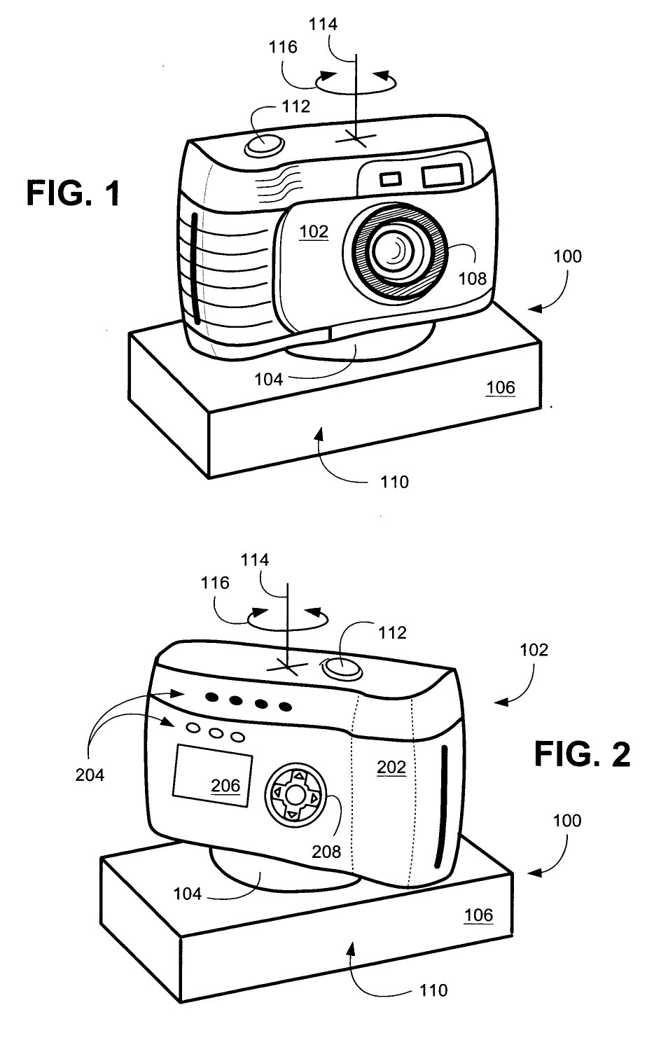

Embodiments of the camera docking station 100 (FIGS. 1-8) provide a system and method for docking a camera to a processing system such that the direction of the camera may be adjusted by the user while the camera is docked to the camera docking station 100. One embodiment of the camera docking station 100 may be positioned by the user such that the camera 102 (FIGS. 1 and 2) may capture still images or video images while the camera 102 is in communication with a processing system via the camera docking station 100. With this embodiment, the user may rotate the docked camera to access controls on the back side 202 (FIG. 2) of the camera 102 to adjust image capture parameters, such as focus, zoom, hue, exposure or the like. Then, the user may rotate the docked camera 102 such that the camera lens 108 (FIG. 1) is directed to the user or another object of interest. Accordingly, a camera 102 may support a video conferencing functionality by providing a stream of images and/or a video to another party(s) via the Internet.

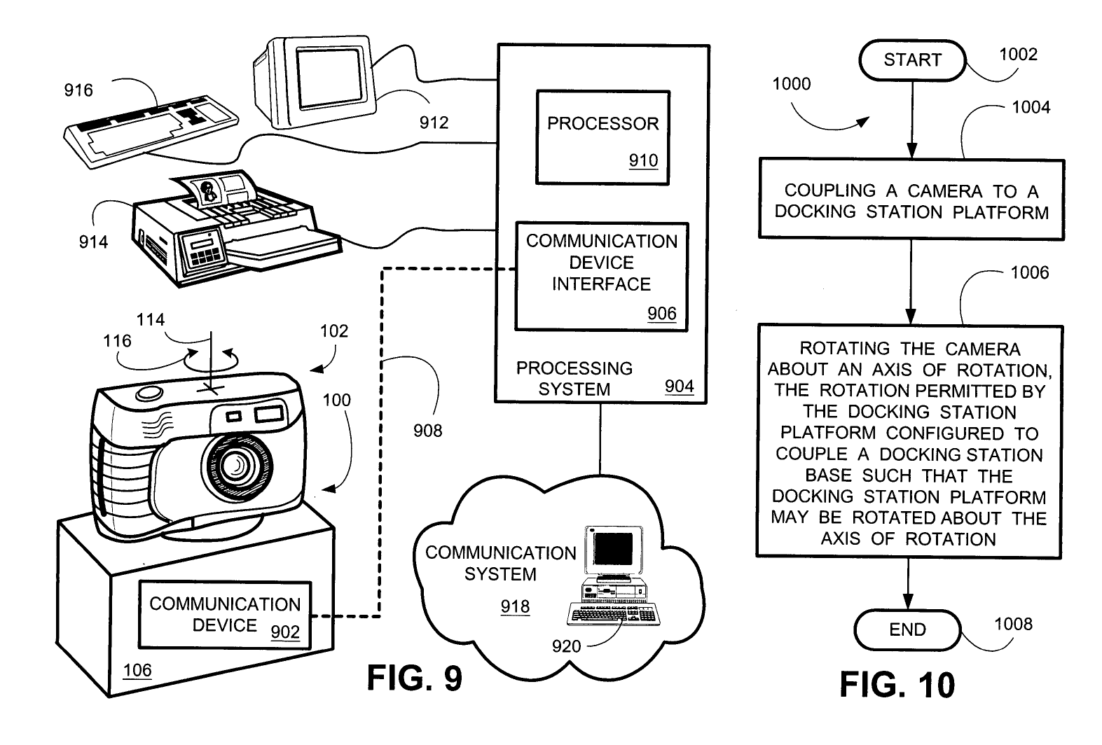

FIG. 1 is a perspective view of a camera 102 coupled to an embodiment of a camera docking station 100. The camera docking station 100 includes a platform 104 and a docking station base 106. This exemplary view illustrates the camera lens 108 pointing outwards from the front surface 110 of the docking station base 106. When a user is positioned across from the camera docking station 100 and facing the front surface 110, such as when the user is seated while working on the processing system 904 (FIG. 9), the user may conveniently access various controls located on the top of the docked camera 102, such as shutter button 112.

As described in greater detail hereinbelow, the docked camera 102 may be rotated about the axis of rotation 114 in a counterclockwise or a clockwise direction, as indicated by the directional arrow 116. Accordingly, the user may adjust the position of the docked camera 102 by rotating the camera 102 about the axis of rotation 114 to direct the lens 108 at an object of interest. For example, but not limited to, the user may be video conferencing with another party(s). The user may, during one portion of the video conference, direct the camera lens 108 at himself such that an image of the user is captured by the docked camera 102 and communicated to the processing system 904 (FIG. 9) via the camera docking station 100. During another portion of the video conference, the user may adjust the position of the docked camera 102 to provide images of another object of interest. For example, the user may wish to show the other party(s) an image of a pet, art object, business diagram or the like. The user simply rotates the camera 102 about the axis of rotation 114 to aim the camera lens 108 at the object of interest.

FIG. 2 is a perspective view of the back side 202 of the camera 102 coupled to an embodiment of the camera docking station 100. This exemplary view illustrates the back side 202 pointing outwards from the front surface 110 of the docking station base 106. When a user is positioned across from the camera docking station 100 and facing the front surface 110, the user may conveniently access various controls 204 located on the back side 202 of the camera 102. Accordingly, the user may adjust image capture parameters, such as focus, zoom, hue, exposure or the like with the controls 204. Furthermore, the user may view captured images on the display 206. If the camera 102 includes a multifunction controller 208 to operate a menu displayed on display 206, the user may rotate the docked camera 102 about the axis of rotation 114 to better view the display, access the controls 204, and/or access the multifunction controller 208.

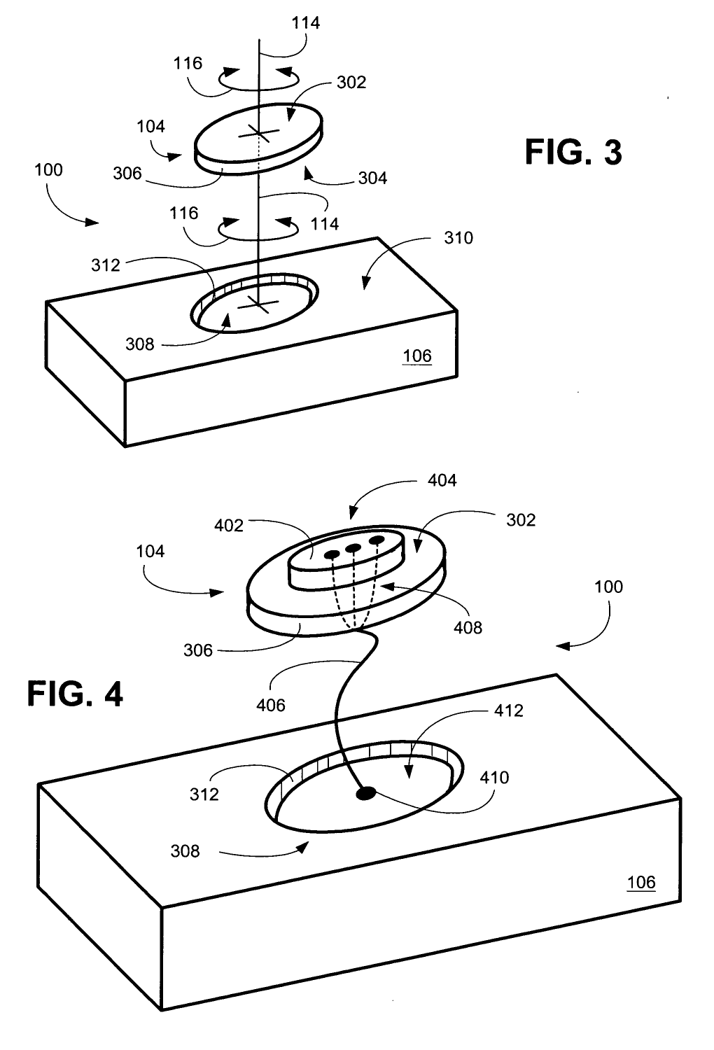

FIG. 3 is an exploded view of the docking station platform 104 separated from an embodiment of the docking station base 106. The docking station platform 104 is a body that includes a top surface 302, a bottom surface 304 and a side surface 306. The docking station base 106 includes a base cavity 308 on the top surface 310.

The platform 104 is generally round in form, and slightly smaller in diameter than the base cavity 308, such that at least a portion of the platform 104 may be inserted into the base cavity 308 while permitting rotation of the platform 104 about the axis of rotation 114. In various embodiments, there may be a low amount of frictional contact between the platform side surface 306 and the base cavity sidewall surface 312. In other embodiments, there is no frictional contact. It is understood that the platform 104 is illustrated as a disk for convenience. Accordingly, an unlimited number of designs may be selected for the platform 116.

FIG. 4 is another exploded view of an embodiment of docking station platform 104 separated from the docking station base 106. A camera connector member 402 resides on the platform top surface 302. The member 402 is configured to mate with a matching recess in camera 102 (FIGS. 1 and 2) such that the camera 102 may be coupled to the camera docking station 100. In one embodiment, the member 402 is configured to provide sufficient structural support so that the camera 102 is rigidly fixed in position with respect to the platform 104 when docked to the camera docking station 100.

Camera connector member 402 employs a plurality of exposed connectors 404 configured to mate with corresponding connectors in the recess of the camera 102. When the camera 102 is docked with the camera docking station 100, the connectors 404 are communicatively coupled with the corresponding connectors of camera 102. The connectors 404 are illustrated for convenience as “buttons” protruding from the top of member 402. For convenience, only three connectors 404 are illustrated, although any suitable number may be used depending upon the connection requirements of the camera 102. It is understood that any suitable connector device may be used by alternative embodiments, and that the connector devices may reside in any suitable location on the member 402 and/or the platform 104. Non-limiting examples of connector devices also include pins, holes, bars, slots, latches, clips and/or any suitable means configured to communicatively couple the camera 102 with the camera docking station 100.

In the illustrated embodiment of the camera docking station 100 in FIG. 4, the connectors 404 are also coupled to wire connection 406 via suitable connectors 408. Wire connector 406 is a flexible connector that facilitates rotation of the camera docking station platform 104 as described above. The wire connector 406 extends through a hole 410 in the bottom surface 412 of the base cavity 308. It is understood that the wire connector is communicatively coupled to a communication device 902 (FIG. 9), described in greater detail hereinbelow, residing inside the docking station base 106. The communication device is configured to provide communication between the camera 102 and the processing system 904 (FIG. 9).

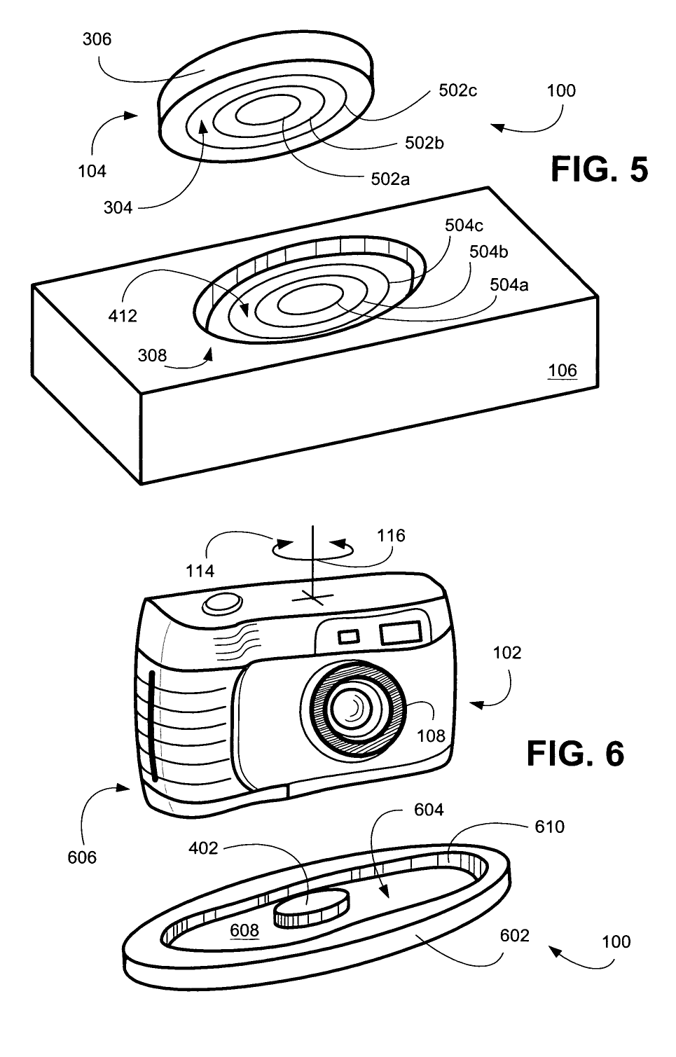

FIG. 5 is an exploded view of another embodiment of docking station platform 104 separated from the docking station base 106. A camera connector member (not shown) resides on the platform top surface. A plurality of connection rings 502a-c reside on the platform bottom surface 304. A corresponding plurality of connection rings 504a-c reside on the bottom surface of base cavity 308. For convenience, only three connector rings 502a-c and 504a-c are illustrated, although any suitable number may be used depending upon the connection requirements of the camera 102 (FIGS. 1 and 2). When the platform 104 is inserted into the base cavity 308, the connection rings 502a-c are in contact with their respective connection rings 504a-c. For example, connection ring 502a is in contact with connection ring 504a. Accordingly, when the camera 102 is docked with the camera docking station 100, the camera 102 may communicate with the processing system 904 (FIG. 9) via the camera docking station 100 since the connection rings 502a-c and 504a-c are communicatively coupled with each other. As the docked camera 102 is rotated about rotation axis 114 (FIGS. 1-3), the connection rings 502a-c remain in contact with their respective connection ring 504a-c.

In an alternative embodiment, one set of connection rings may be replaced with a pin or other suitable protrusion. For example, a pin or other suitable protrusion (not shown) may be substituted for ring 502a. As the platform 104 is rotated about rotation axis 114, the pin remains in contact with its respective connection ring 504a.

The connection rings 502a-c are understood to be coupled to the corresponding plurality of connectors 404 via a corresponding plurality of connectors 408 (FIG. 4). Similarly, each of the connection rings 504a-c are coupled with corresponding wire connectors (not shown) to a communication device 902 (FIG. 9), described in greater detail hereinbelow, residing within the docking station base 106. As noted above, the communication device 902 is configured to provide communication between the camera 102 and the processing system 904.

The above-described illustrative embodiments of the platform 104 and the associated connections that facilitate communication between the docked camera 102 and processing system 904 when the docked camera 102 is rotated about the rotation axis 114, is understood to represent two illustrative examples. Other embodiments may employ other systems and devices to provide the communication between the camera 102 and the processing system 904 when the docked camera 102 is rotated about the rotation axis 114.

FIG. 6 is a perspective view of an embodiment of a platform 602 with a platform cavity 604 corresponding to the base 606 of camera 102. When the camera 102 is coupled to the platform 602 by inserting the camera base 606 into the cavity 604, the docked camera 102 is fixed in position with respect to camera base 606.

A camera connector member 402 resides on the platform cavity top surface 608. As described above, the member 402 is configured to mate with a matching recess in camera 102 such that the camera 102 may be coupled to the camera docking station 100. However, member 402 may be configured to provide little or no structural support to the camera 102 in some embodiments. In other embodiments, member 402 is omitted and the connections between camera 102 and base 606 reside in other convenient locations. The docked camera 102 is rigidly fixed in position with respect to the platform 602 when docked to the camera docking station 100 because the sidewall 610 of the platform cavity 604 is in frictional contact with the base 606 of camera 102.

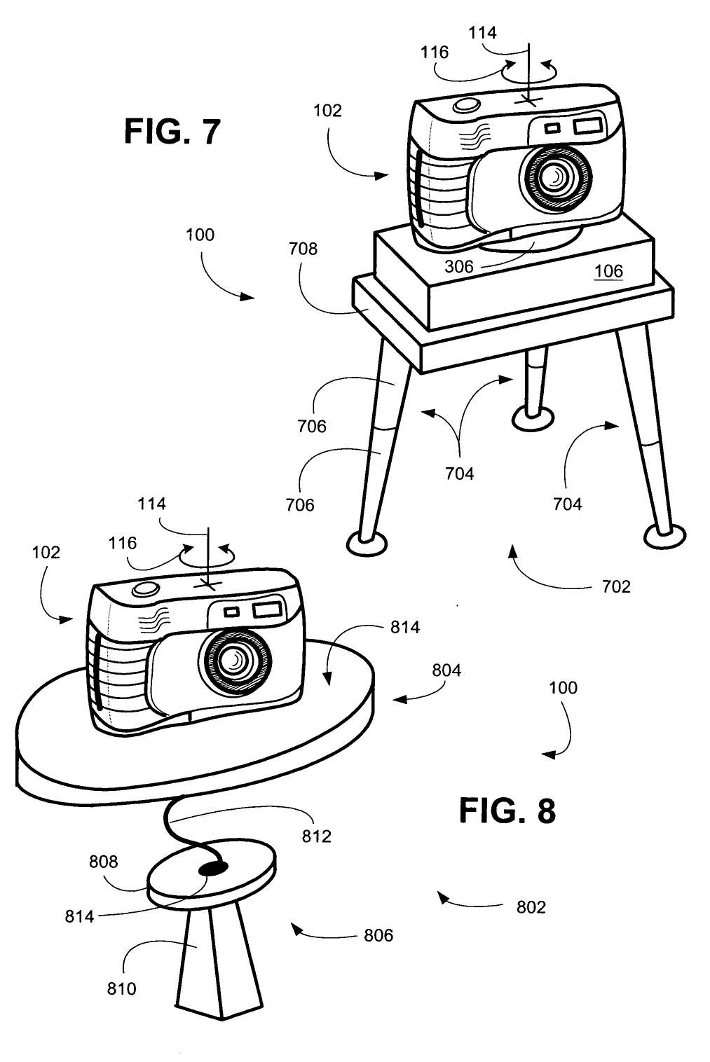

FIG. 7 is a perspective view of an embodiment of a camera docking station 100 comprising a tripod 702. When the camera 102 is coupled to the camera docking station 100, the legs 704 of tripod 702 permit the user to locate the camera 102 coupled to the camera docking station 100 at any desirable location. Accordingly, the camera 102 may be aimed in any desired direction. Furthermore, images may be captured by camera 102 over any angle range of interest and the images may be then combined to generate a wide-angle image. For example, images may be captured as the docked camera 102 is rotated about the axis of rotation 114 by 360 degrees, and then the images may be combined to generate a single image with a 360 degree view.

In one embodiment, legs 704 may be extendable using any suitable extension means, such as a telescoping system, a plurality of leg members 706 suitably hinged together to provide folding of the leg members 706 together, or a plurality of separate leg members 706 that are coupled together. For convenience, three legs 704 are illustrated. Accordingly, it is understood that the length of leg members 706 and/or number of leg members 706 may be selected to provide any desired height and/or stability of the camera docking station 100.

For convenience, the legs 704 are illustrated as coupled to a support base 708.

Support base 708, in one embodiment, is a separate member that is coupled to docking station base 106 using any suitable connection device (not shown). In another embodiment, the legs 704 are directly coupled to the docking station base 106. In some embodiments, legs 704 may be permanently fixed to the support base 708 or to the docking station base 106, or may be detachable in other embodiments.

For convenience, the camera 102 is illustrated as being coupled to a platform 104 (FIGS. 1-4). However, a platform 602 (FIG. 6) or a pedestal platform 804 (FIG. 8) may be used by other embodiments.

FIG. 8 is a perspective view of an embodiment of a camera docking station 100 comprising a pedestal 802. Pedestal 802 comprises a pedestal platform 804 and a pedestal base 806. Pedestal base 806 comprises a pedestal base member 808 and a pedestal stand 810. Camera 102 may be coupled to pedestal platform 804 as described above for any of the embodiments of the platform 104 (FIGS. 1-4) or the platform 602 (FIG. 6).

Pedestal platform 804 is illustrated generally as disc-shaped and larger than the camera 102. This embodiment may be desirable for point-of-purchases displays in that marketing devices may be placed on the pedestal platform 804 along with camera 102. Marketing devices include, but are not limited to, literature, small displays, related devices or other suitable materials. It is understood that the pedestal platform 804 is illustrated as a disk for convenience. Accordingly, an unlimited number of designs may be selected for the pedestal platform 804.

Pedestal platform 804 is communicatively coupled to a pedestal base member 808 via wire connector 812 for convenience. The wire connector 812 extends through a hole 814. It is understood that the wire connector 812 is communicatively coupled to a communication device 902 (FIG. 9), described in greater detail hereinbelow, residing inside the pedestal base 806. The communication device 902 is configured to provide communication between the camera 102 and the processing system 904 (FIG. 9). In another embodiment, the communication device 902 resides in the pedestal platform 804 and the wire connector 812 resides inside the pedestal base.

For convenience, pedestal platform 804 is illustrated as communicatively coupled to pedestal base member 808 via wire connector 812. However, pedestal platform 804 may be communicatively coupled to pedestal base member 808 by other systems, such as those described for the platforms 104 of FIGS. 4 or 5.

The pedestal base member 808 is configured to couple to the bottom of the pedestal platform 804 using any suitable connection device that allows rotation of the pedestal platform 804 and camera 102 about the axis of rotation 114. Since the number of devices that may be used to couple the pedestal base member 808 and the pedestal platform 804 are numerous, such devices are not described in detail herein.

In other embodiments, the pedestal platform 804 is rigidly coupled to the pedestal base member 808 or directly to pedestal stand 810. Rotation of the camera 102 about the axis of rotation 114 is enabled by using the above-described platforms 104 (FIGS. 1-5) or 602 (FIG. 6). In yet another embodiment, the pedestal platform 804 is sufficiently large that a plurality of camera 102 may be coupled to the pedestal platform 804 via a plurality of platforms 104 and/or 602, thereby providing a point-of-purchase display that provides for display and rotation of a plurality of image capture devices.

FIG. 9 is a block diagram of a communication device 902 in communication with camera 102 and a processing system 904. Communication device 902 may reside in the docking station base 106, in the platforms 104 (FIGS. 1-5), in the pedestal stand 810 (FIG. 8), or in the pedestal platform 804. Communication device 902 communicates with communication device interface 906, as generally indicated by the communication path 908, illustrated as a dashed line for convenience. Communication device interface 906 is illustrated as residing within the processing system 904 for convenience, though it may reside outside in another location in other embodiments.

Processing system 904 is configured to receive information from camera 102, via any of the above-described embodiments of the camera docking station 100. The received information may be processed by processor 910 for displaying on display 912 or for printing on printing device 914. The user controls processing of information received from the camera 102 via a keyboard 916 or other suitable device.

In one embodiment, camera 102 facilitates video conferencing functionality by providing a stream of images and/or a video to another party(s) via a communication system 918, such as, but not limited to, the Internet. Accordingly, a remote party may view images captured by camera 112 on a remote device 920.

The communication device 902 is configured to communicate with the communication device interface 906 using any suitable communication medium and/or format. In one embodiment, a physical wire connector (not shown) couples the communication device 902 with the communication device interface 906. In other embodiments, an infrared medium, cable medium, microwave medium, radio frequency (RF) medium or even an intermediary communication system may be employed. For example, the intermediary system may be a telephony system, the Internet, or any other communication medium.

FIG. 10 shows a flow chart 1000 illustrating a process of using an embodiment of the camera docking station 100. The blocks of flow chart 1000 may occur out of the order noted in FIG. 10, or may include additional functions. For example, two blocks shown in succession in FIG. 10 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process begins at block 1002. At block 1004, a camera is coupled to a docking station platform. At block 1006, the camera is rotated about an axis of rotation, the rotation permitted by the docking station platform configured to couple to a docking station base such that the docking station platform may be rotated about the axis of rotation. The process ends at block 1008.

It should be emphasized that the above-described embodiments are merely examples of implementations. Many variations and modifications may be made to the above-described embodiments. All such modifications and variations are intended to be included herein within the scope of this disclosure and protected by the following claims.

1. A system which docks a camera, comprising:
a base; and
a platform configured to dock with the camera and configured to couple to the base such that the platform may be rotated about an axis of rotation.

2. The system of claim 1, wherein the camera, when docked to the platform, may be rotated about the axis of rotation.

3. The system of claim 1, further comprising a connection member coupled to the platform and configured to insert into a matching recess residing in the camera such that when the camera is docked to the platform, the camera is rigidly coupled to the connection member.

4. The system of claim 1, further comprising a plurality of connectors configured to communicatively couple the docked camera with a processing system.

5. The system of claim 1, further comprising at least one leg coupled to the base.

6. The system of claim 1, further comprising a cavity residing in a top surface of the platform, the cavity corresponding to the base of the camera such that when the camera is docked to the platform, the camera is rigidly coupled to the platform.

7. The system of claim 1, wherein the platform further comprises a pedestal platform, the pedestal platform configured to dock the camera and to display marketing devices placed on the pedestal platform.

8. The system of claim 7, further comprising:
a pedestal base; and
a plurality of pedestal platforms wherein a plurality of cameras may be docked.

9. The system of claim 1, further comprising a communication device, wherein the communication device uses a communication medium to communicatively couple the docked camera to a processing system.

10. The system of claim 9, wherein the communication medium comprises at least one selected from a group consisting of a wire connection medium, an infrared medium, a cable medium, a microwave medium, a radio frequency (RF) medium, an intermediary communication system may be employed, a telephony system medium and an Internet medium.

11. A method for docking a camera, the method comprising the steps of:
coupling the camera to a docking station platform; and
rotating the camera about an axis of rotation, the rotation permitted by the docking station platform configured to couple to a docking station base such that the docking station platform may be rotated about the axis of rotation.

12. The method of claim 1 1, further comprising the step of communicating information from the camera to a processing system.

13. The method of claim 12, wherein the step of communicating further comprises the step of communication with a communication medium used by a communication device.

14. The method of claim 13, wherein the communication medium comprises at least one selected from a group consisting of a wire connection medium, an infrared medium, a cable medium, a microwave medium, a radio frequency (RF) medium, an intermediary communication system may be employed, a telephony system medium and an Internet medium.

15. A system for docking a camera, comprising:
means for physically coupling the camera to a docking station platform;
means for communicatively coupling the camera to a docking station platform; and
means for rotating the camera about an axis of rotation, the rotation permitted by the docking station platform configured to couple to a docking station base such that the docking station platform may be rotated about the axis of rotation.

16. The system of claim 15, further comprising means for rigidly coupling the camera to the docking station platform.

17. The system of claim 15, further comprising means for communicating information from the camera to a processing system.

18. The system of claim 17, wherein the means for communicating further comprises means for communicating with a communication medium used by a communication device.

19. The system of claim 18, wherein the communication medium comprises at least one selected from a group consisting of a wire connection medium, an infrared medium, a cable medium, a microwave medium, a radio frequency (RF) medium, an intermediary communication system may be employed, a telephony system medium and an Internet medium.

20. The system of claim 15, wherein the means for communicatively coupling further comprises means for coupling the camera to a pedestal platform such that marketing devices are placed on the pedestal platform.
